(19) United States
(12) Patent Application Publication
(10) Pub. No.: US 2014/0106313 A1
(43) Pub. Date: Apr. 17, 2014

(54) METHOD AND ARTICLE OF MANUFACTURE FOR CUSTOMIZED DIETARY MENU

(71) Applicant: JOHN STAN STEELE, CASTRO VALLEY, CA (US)

(72) Inventor: JOHN STAN STEELE, CASTRO VALLEY, CA (US)

(21) Appl. No.: 13/706,618

(22) Filed: Dec. 6, 2012

Related U.S. Application Data
(60) Provisional application No. 61/712,265, filed on Oct. 11, 2012.

(51) Int. Cl. G09B 19/00

(52) U.S. Cl. CPC G09B 19/0092
USPC 434/127

(57) ABSTRACT

The invention relates, generally, to a customized household dietary menu system and provides a method for creation of said system, as well as an article of said system.

### CROSS-REFERENCE TO RELATED APPLICATIONS

This application claims the benefit of U.S. Provisional Application for Patent Ser. No. 61/712,265, filed on Oct. 11, 2012.

### BACKGROUND

1. Field of the Invention

The present invention relates to home menu and grocery planning and, more particularly, to a method for producing customized household menus with family- or housemate-specific photos, food item preferences and meal calendars and to the article of such customized menu.

2. Description of Prior Art

As described further below, each menu cover will display a picture of choice from the customer and a personalized or customized title of the menu (e.g. “The Steele Family Home Menu” or “The Jane & Joe Roommate Menu”). Each submenu (or “meal menu”) will display a photo of the customer's choosing, as well as an image, food identification number and calorie count for each food item that the customer selects for inclusion in the respective submenu. Generally, each menu will contain breakfast, lunch and dinner submenus, though additional submenus may be created (e.g., afternoon snack menu).

The household menu also contains a separate page that lists the food items and corresponding identification numbers of each food item for ease of reference. A five-week adaptable calendar enables meal planning by displaying for each day a section to mark the date and sections for noting the food identification numbers of each planned meal.

A two-sided grocery list accommodates grocery planning for two different stores, two different individuals, or any other customer-specific grocery planning preference. The grocery list attaches and detaches from the menu by way of magnets that can also be used to hang the grocery list on a magnetic surface, such as a refrigerator or shopping cart. The menu pages are secured using an open binder system that allows for addition, removal, or replacement of pages in the household menu. To allow further customization, as well as meal and grocery planning, all pages comprising the menu are laminated and can be temporarily marked and remarked using a dry erase pen.

Indeed, unique devices and systems have been concocted to satisfy various aspects of the meal and grocery planning process, but none harnesses the full set of advantages as the present invention through user customization and provider integration.

There are systems for cataloging recipes for ease of meal planning (U.S. patent application publication no. U.S. 2002/0079690 A1) and grocery shopping (U.S. design patent No. D 256,475 and U.S. patent application publication no. U.S. 2002/0013737 A1). Other systems, such those described in U.S. Pat. Nos. 4,979,901, 4,065,863, 5,338,202, 3,491,715, 4,151,668, 4,689,019, and 4,652,241, provide physical meal planning systems or devices that are generally suitable for use by individuals. Other systems, such as those described in U.S. patent application publication nos. U.S. 2009/0144081 A1, U.S. 2001/0025279 A1, and U.S. 2002/0029149 A1 and U.S. Pat. No. 7,753,681, provide a computerized means for selecting and planning custom dietary menus but do not offer an integrated physical component for multi-user reference, meal planning input, and grocery list maintenance. Thus, there remains a need for a household meal planning apparatus that is created using a modern technological method and easily implemented by any household member using a more traditional notation and reference method.

### SUMMARY

Using a computer-implemented, online approach for creating household meal menus, customers specify foods for inclusion in breakfast, lunch, dinner or other meal (e.g., snack or fourth meal) submenu pages based on the menu product selected. According to one approach, customers provide item selection criteria to a provider that uses the items indicated by the item selection criteria to design, manufacture and deliver to the customer a customized meal menu.

The customized dietary menu (also referred to as “home menu” or “meal menu”) addresses the everyday question: What's for dinner? The product can be used by any individual, couple or group who perform meal planning on a daily, weekly or monthly basis to plan their meals and shopping ahead of time.

In one embodiment, user—such as a family member—accesses provider's user interface via an interne browser-based or an independent computer application, selects a menu type (e.g., family home menu or family camping menu), selects from provider-specified options or enters user-specified food items for each submenu (i.e., breakfast, lunch, dinner or other meal), creates a user profile, uploads personal photographs, and transmits all user-input data to provider. In response, provider provides the menu, as customized by user, by associating calorie information and numerical identification with each user-selected food item, arranging the food items and user-uploaded photographs on each specified submenu page (or “meal page”), printing and laminating each menu page, affixing magnetic adhesion system to detachable grocery list pages, organizing menu pages into an open binder assembly, and shipping the customized menu product to user. Likewise, user can order replacement or additional submenu pages, and provide can provide individual laminated pages as ordered.

The ease of advanced meal planning promotes resolution of the common diet-related struggles, including setting and complying with a grocery or meal budget, limiting waste by maximizing inclusion of available ingredients at meal time, eating healthier as a general measure, and efficiently and effectively meeting the dietary requirements and restrictions of different members of a household. The customized dietary menu can be used to promote better eating habits on a regular basis or during limited periods such as the holidays, travel or while accommodating houseguests.

The sum of these objectives—including associated advantages—unifies with the novel user-input system and the novel article of the custom home menu, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

Embodiments of the invention are illustrated by way of example, and not by way of limitation, in the figures of the accompanying drawings.

FIG. 1 illustrates the relationship between the customer and provider via connection through the interne.

FIG. 2 diagrams the overall process of enabling customization of a dietary menu, soliciting and receiving user-specified menu features, and processing user specifications in creation and delivery of a customized dietary menu.

FIGS. 3A-C show the steps of a user's online activities, software and provider's process, and manual assembly process, respectively.

FIG. 4 illustrates the user interface for user input of food item selection criteria.

FIG. 5 illustrates the user interface for user input of profile criteria and personal pictures.

FIGS. 6A-D show generic depictions of the assembled menu, specifically showing the binder system and magnetic, detachable grocery list component.

FIGS. 7A-E illustrate templates for customizable menu cover page, submenu page, food item code page, five-week menu planning page and two grocery list pages, respectively.

### DETAILED DESCRIPTION

Embodiments of the invention are now described with reference to the drawings. Additional aspects and features of the system will also be appreciated by one skilled in the art as further described below.

### 1. Functional Overview.

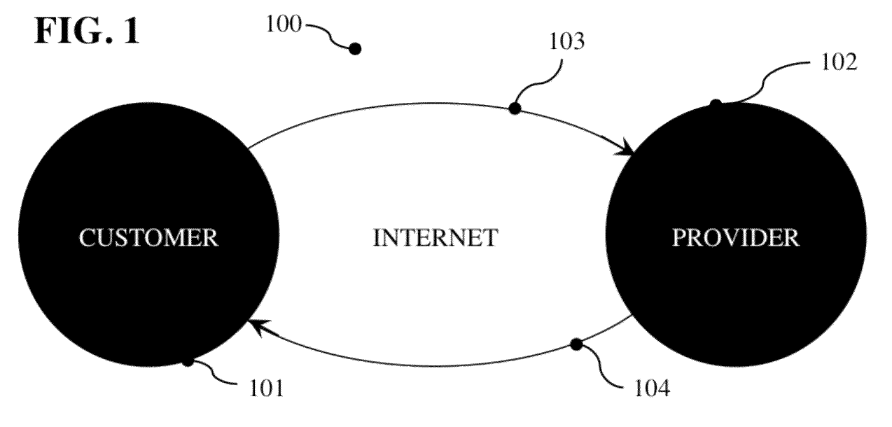

FIG. 1 is a diagram 100 that illustrates an approach for providing customized dietary menus (or “menu products”) to customers according to the various embodiments described herein. Examples of menu products include family home menu, camping menu, roommate menu, holiday menu, party menu and others. “User” and “customer” are used interchangeably.

According to one embodiment, a user 101 provides user-specified criteria to provider 102 over a link 103. User-specified criteria includes selected menu product, selected food items, profile data and personal photographs. Link 103 may be any medium for transferring data between customer 101 and provider 102 and the invention is not limited to any particular medium. Examples of link 103 include, without limitation, a network such as a LAN, WAN or the Internet, a telecommunications link, a wire or optical link, or a wireless connection.

In response to receiving user-specified criteria, provider 102 processes the customer's request and provides the customized menu product to customer 101 over a delivery channel 104. Delivery channel 104 may be implemented by any mechanism that provides for the transfer of items, and the invention is not limited to any particular mechanism.

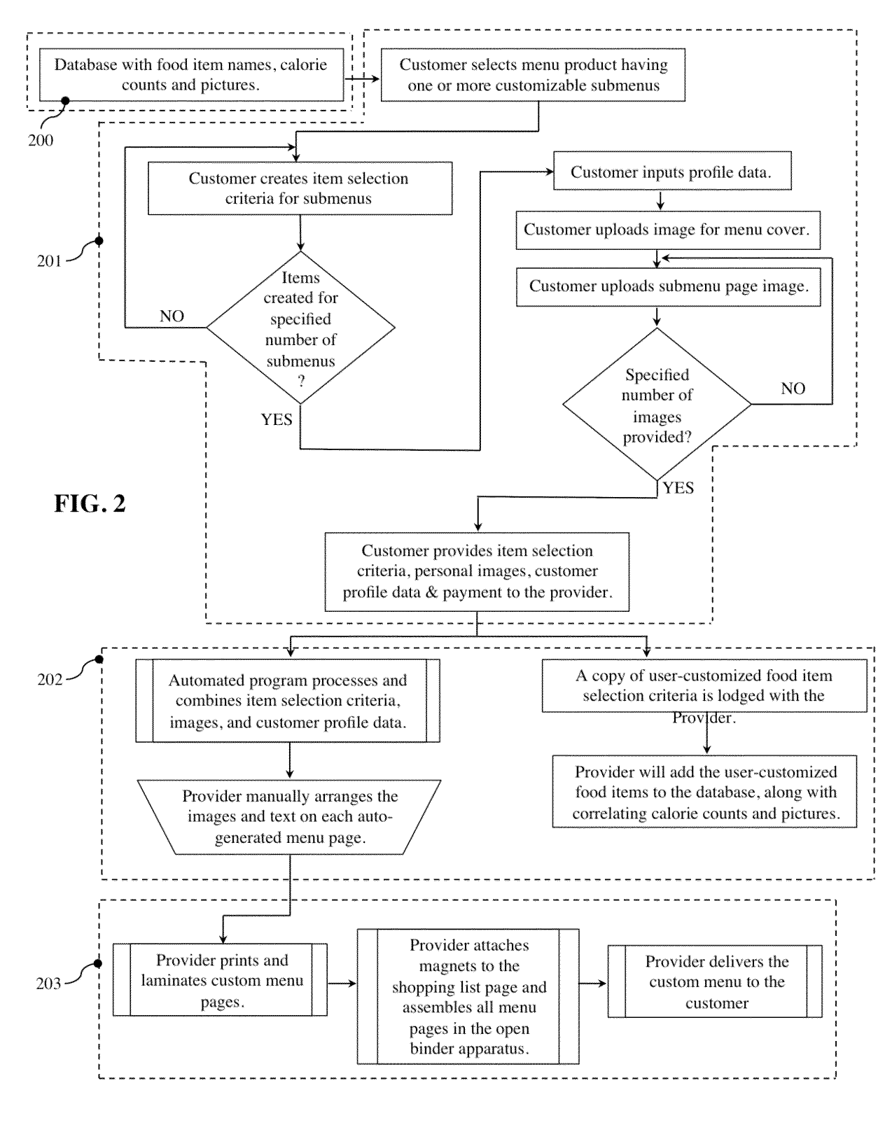

FIG. 2 is a flow diagram providing an overview of the four main customer- and provider-side processes of creating a custom household menu. Initially, customer accesses the provider's server, menu product and food item database 200 via a user interface 201 where customer inputs user-specified criteria. Once customer completes menu selection and customization, user-specified data criteria are submitted to provider, where they are processed into presentable, functional menu pages 202. Provider then manufactures the specified menu product 203.

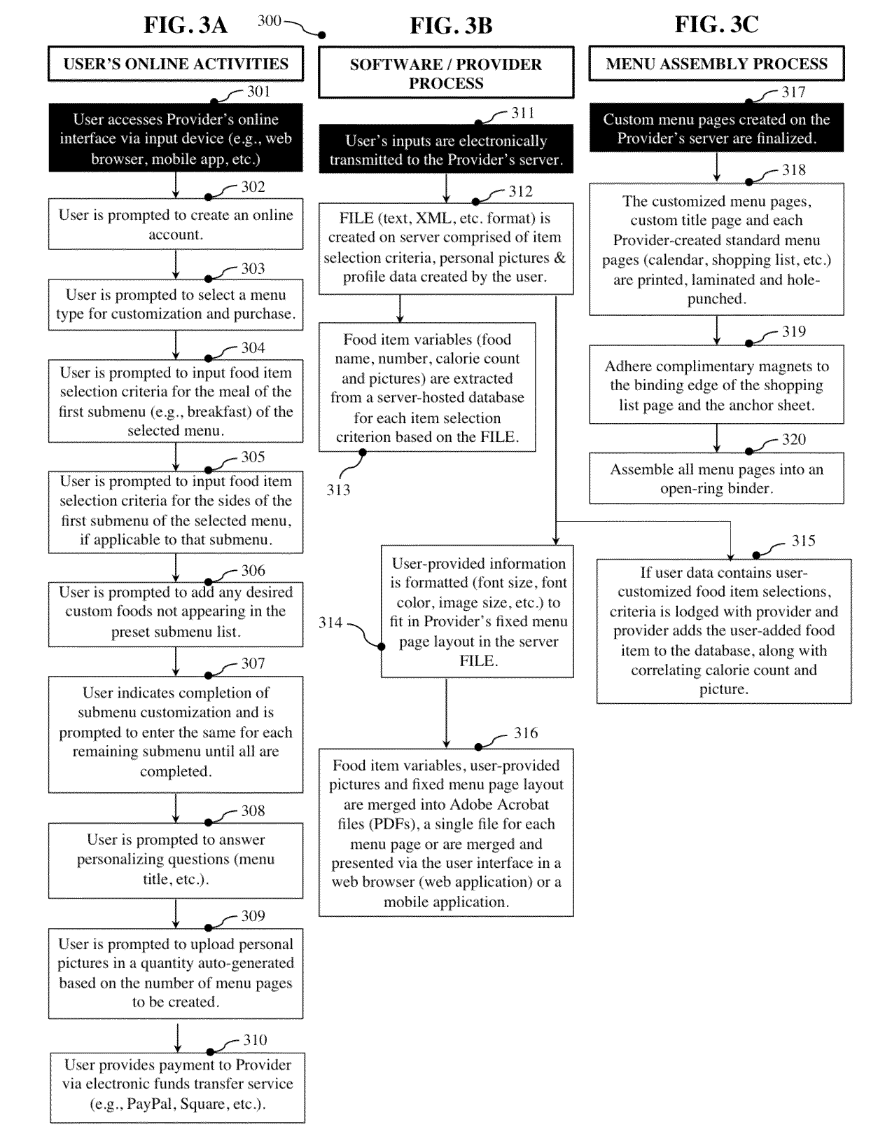

FIG. 3 is a block diagram 300 that illustrates an approach for creating a customized menu. The process begins when the customer accesses the provider's menu customization database via a user interface 301, which is stored on provider's server, and is prompted to create a user account 302. From the user interface, the customer selects the desired menu product 303, which may be a new, complete menu or a replacement or supplemental submenu. The customer then creates item selection criteria for the first submenu as specified by the selected menu product 303. This series of steps includes selection of pre-defined main course 304 and side dish 305 foods that customer can select by checking associated boxes, as well as an option for adding a food that is absent from the list 306. Once all food items are selected for the specified submenu, the customer indicates completion by clicking on a link 307. If food items have been specified for all submenus, the customer is directed to select food items for the next submenu.

If the customer has completed item selection for all submenus, the customer will be prompted to input profile criteria 308, which include household information that is used to generate the custom title on the cover page of the menu. User then uploads a menu cover photo and personal photos 309 in a quantity specified by the automated system based on the number of submenu pages that will be produced given the number of food items selected by the customer. User finalizes the order by providing payment 310 via a specified online platform and submitting the item selection criteria, personal images, and profile data to the provider 311.

Customer-provided information is then processed by the provider. An automated, server-based script 312 generates customized, editable menu pages that can only be accessed by the provider. The script, in part, draws data from a provider-defined database containing food item names, identification numbers, images and calorie counts 313. The provider can then format manually arrange the items on each page 314 as to enhance the visibility and overall presentation of the submenu items and personal background photos. If the user-specified data contains user-added food items that were not included in the provider's food item database, a copy of user-customized food item selection criteria is lodged with provider 315 and provider adds the user-added food items to the database, along with correlating calorie counts and pictures.

The provider then produces the menu 316 either by merging the final pages into a format presentable via the user interface in a web browser (web application) or a mobile application or by manufacturing a physical menu product. Production of a physical product may include such operations as finalizing menu page formatting for print 317, printing and laminating the menu pages 318, affixing magnets to the applicable page(s) 319, and assembling the pages into an open binder system 320. Provider then delivers it to the customer via a pre-specified delivery route (e.g. UPS, USPS, FedEx).

### 2. User Interface.

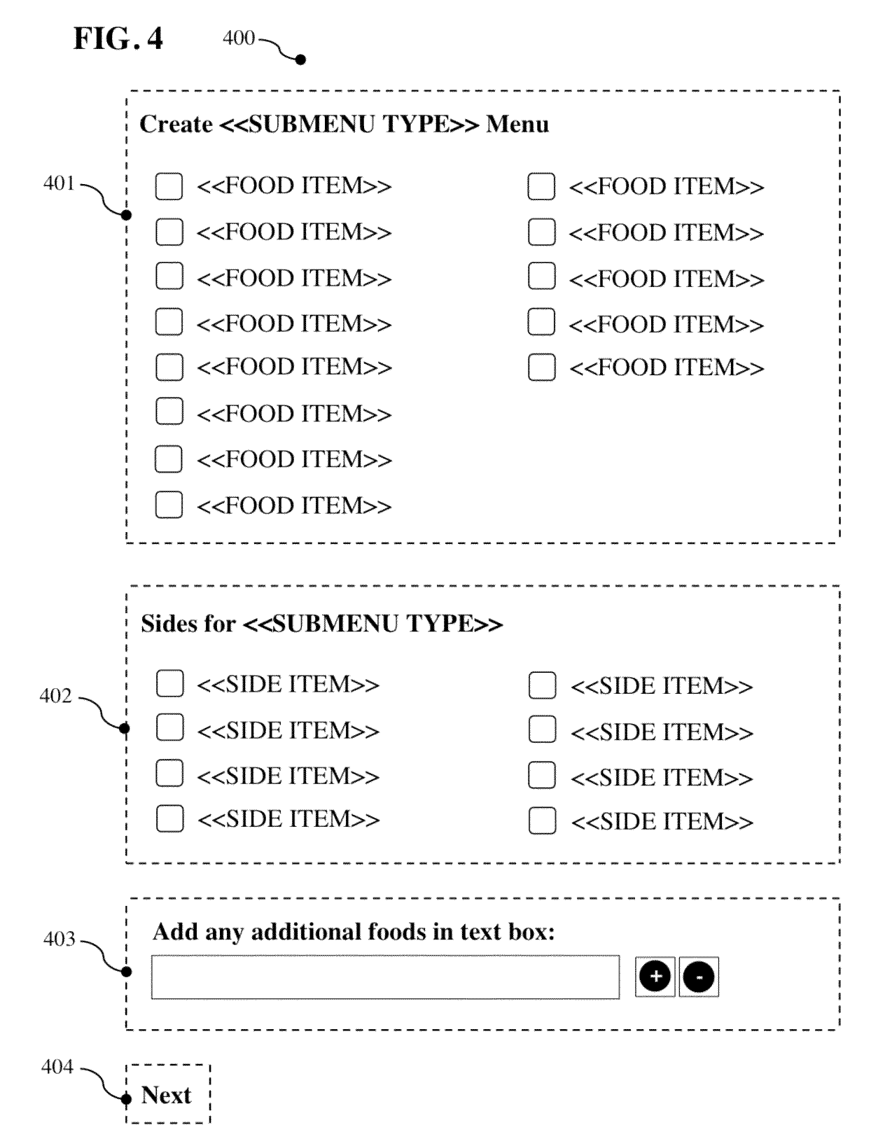

FIG. 4 illustrates an example of a layout 400 of user interface for selecting food items for submenus 204. This layout consists, generally, of four sections: main course options 401, side dish options 402, input field 403 for specifying a food item not included in the main course or side dish pre-set options, and a link 404 for indicating completion of food item selection for the given submenu.

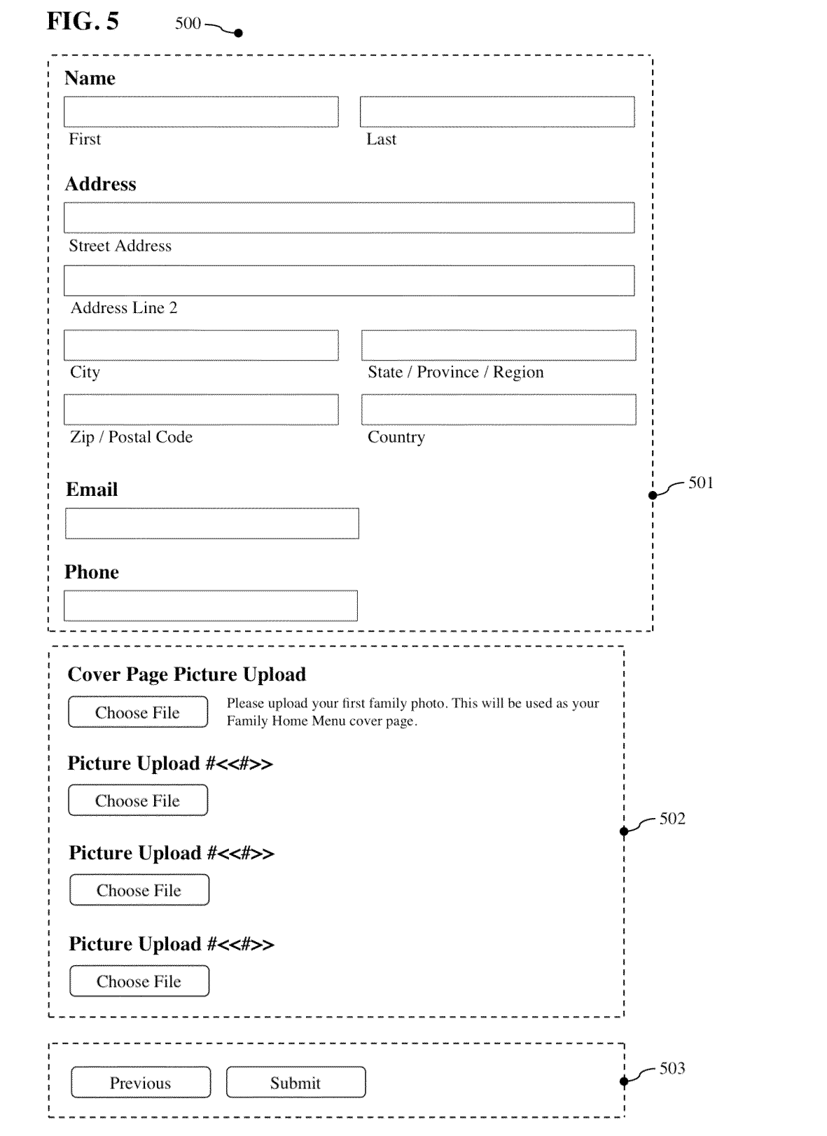

FIG. 5 illustrates an example of a layout 500 of user interface for providing profile criteria 207 and for uploading user photos 208,209. This layout consists, generally, of three sections: profile criteria input fields 501, user photo upload fields 502, and links 503 for indicating completion of profile criteria input and photo upload or for going back to the user interface for food item selection for submenus.

### 3. Use.

In operation, one uses the menu to plan household meals by selecting food items for meals on a specific day and noting the corresponding identification number on the menu's calendar in the space designated for that day and meal. As the calendar may be marked, erased, and remarked using a dry erase pen, the customer can use the calendar year-round by noting the month and filling in the dates in the spaces provided.

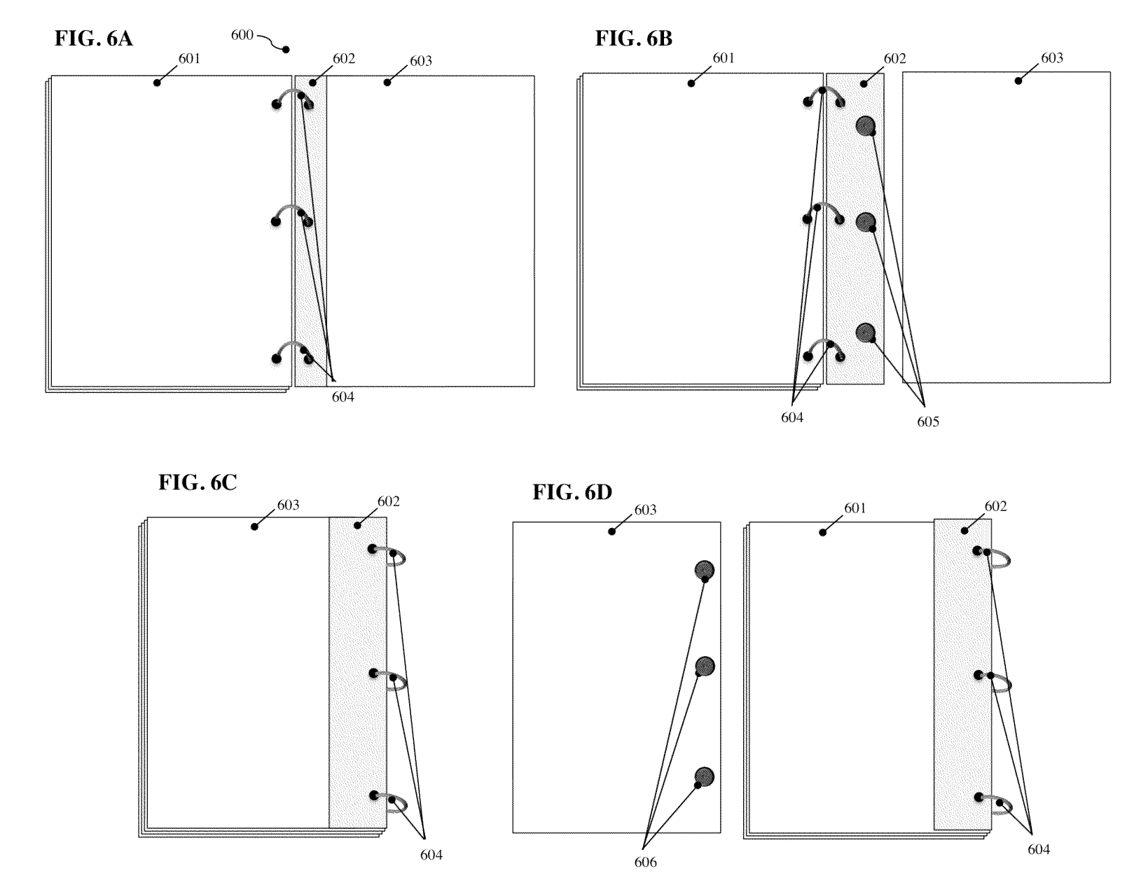

Further, as depicted in the collective illustrations 600 in FIG. 6., one uses the menu to plan grocery shopping by maintaining one or more grocery lists using the detachable, two-sided grocery list 603. Generally, menu pages other than the grocery list, depicted collectively at 601, remain in the binder, though the open binding system 604 does allow for removal and addition of menu pages. Customers can utilize the two-sided list 603 to keep track of groceries that need to be purchased from two different stores, for or by two different people, or for any other user-specific purpose. Since the grocery list is magnetic, having a half-set of magnets 606 complimentary to a second half-set of magnets 605 attached to a binder-secured anchor 602, it can be kept on the refrigerator, attached to a shopping cart while grocery shopping, or just kept in the menu.

As dietary habits or preferences change, the customer can reorder customized meal submenus by selecting such option on the provider's website, reselecting the foods of choice for that submenu, and submitting for order the replacement or additional menu pages. Once received, the customer simply opens the menu binder 604 and adds or replaces the new menu pages.

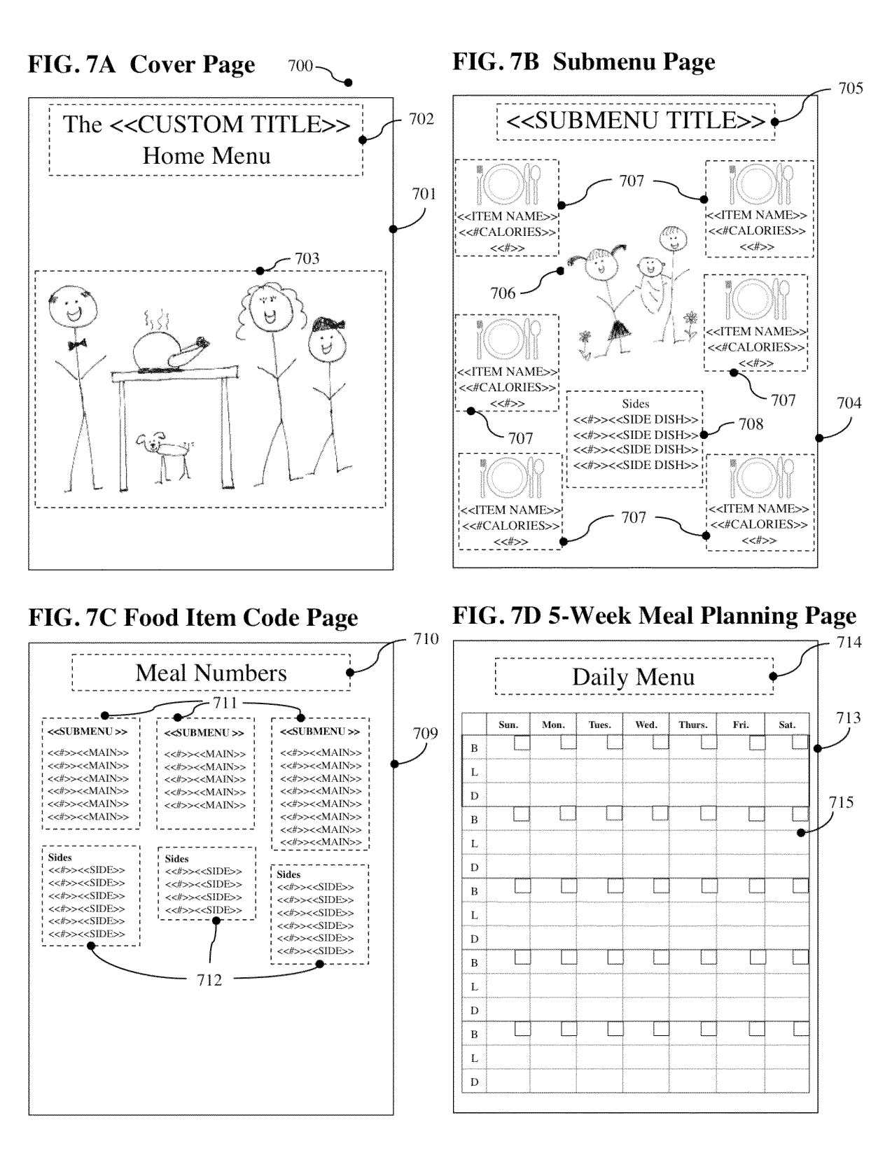

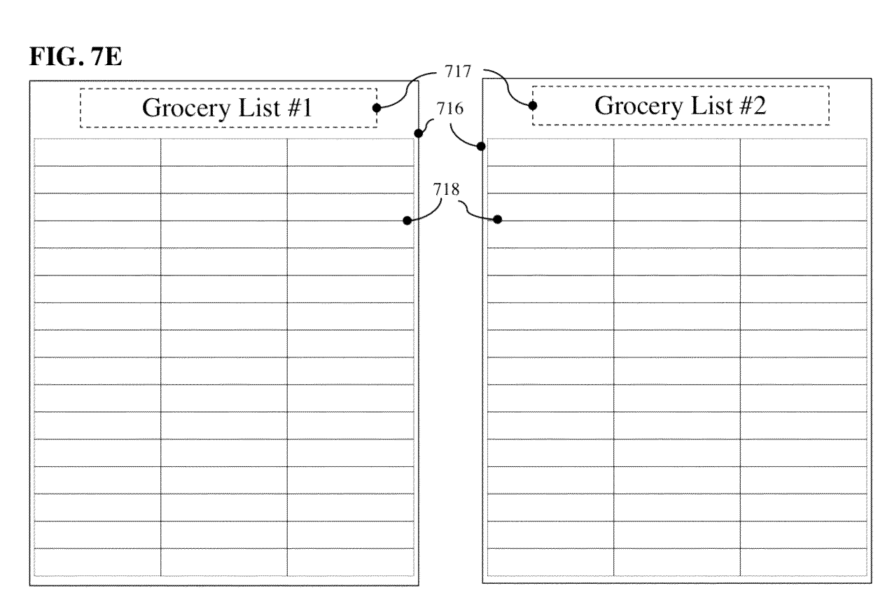

The collective illustrations 700 in FIG. 7 depict examples of menu page layouts. FIG. 7A illustrates a menu cover page 701 having a customized title 702 and a user-specified cover photo 703. FIG. 7B illustrates a submenu page 704 having: a title 705, which is specified according to the selected menu product (e.g., a Family Home Menu might have breakfast, lunch and dinner submenus); a user-specified photo 706; user-selected main course food items 707 with item name, picture, calorie count and identification number; and user-selected side dish items 708 with item name and identification number. FIG. 7C illustrates a food item identification page 709 having: a title 710; a list of user-specified main course food items for each submenu 711 with the title of each submenu and the name and identification number of each main course; a list of user-specified side dish food items for each submenu 712 with the title of each submenu and the name and identification number of each side dish. FIG. 7D illustrates a 5-week meal planning page 713 having a customized title 714 and an adaptable, reusable 5-week meal calendar 715 displaying for each day a section to mark the date and sections for noting the food identification numbers of each planned meal. FIG. 7E illustrates a two-sided grocery list 716 having a customized title on each of two pages 717 and a reusable, markable grid 718 on each page for maintaining grocery lists.

What is claimed is:

1. A method for creating a customized dietary menu, the method comprising the steps of:
accessing a computational system and database of a provider via a user interface;
selecting a menu type for customization and purchase;
creating the item selection criteria comprising each custom submenu;
uploading personal photos in a quantity dictated by menu selection;
providing to the provider the item selection criteria, along with personally selected photos and customer profile data; and
using a customer's item selection criteria, photos and profile information to generate custom submenus.

2. The method as recited in claim 1, further comprising the step of providing payment, from customer to provider, for the customized menu.

3. An article of manufacturer incorporating user-specified criteria provided to a provider via the method of claim 1 into a customized dietary menu, the article comprising the parts of:
laminated title or cover page displaying the customer-chosen photo and the title of the menu as specified by the menu type selected and the customer profile data provided;
laminated customized submenu pages each displaying customer-chosen photo, as well as images, identification numbers and calorie counts of each of the item selection criterion for the respective submenu;
laminated page displaying a list of food names and corresponding identification numbers for each submenu;
laminated calendar containing designated spaces for the food identification numbers of each planned meal;
laminated page for notating grocery list items, embellished with magnets, that are detachable from the menu; and
binding system for holding the menu together while allowing removal and replacement of individual components.
